(19) United States
(12) Patent Application Publication
(10) Pub. No.: US 2015/0067756 A1
(43) Pub. Date: Mar. 5, 2015

(54) Integrated Tap and Home Network Filter

(71) Applicant: ARRIS Enterprises, Inc., Suwanee, GA (US)

(72) Inventor: Stephen J. Kraiman, Doylestown, PA (US)

(21) Appl. No.: 14/477,509

(22) Filed: Sep. 4, 2014

Related U.S. Application Data
(60) Provisional application No. 61/873,497, filed on Sep. 4, 2013.

(51) Int. Cl. H04N 21/436; H04N 21/438

(52) U.S. Cl. CPC H04N 21/43615; H04N 21/438
USPC 725/127

(57) ABSTRACT

A network tap can include a home network filter that is operable to prevent signals at predetermined frequencies from passing from a customer premise onto a service feed servicing the customer premise. In embodiments, one or more MoCA filters can be embedded within a cable tap, each MoCA filter being placed between an interface to a customer premise and a service feed servicing the customer premise. A MoCA filter embedded within a cable tap can block MoCA signals from passing onto a service feed and can reflect MoCA signals back into a customer premise.

### CROSS REFERENCE TO RELATED APPLICATION

This application is a non-provisional application claiming the benefit of U.S. Provisional Application Ser. No. 61/873,497, entitled “Integrated Cable Television Tap and MoCA Filter,” which was filed on Sep. 4, 2013, and is incorporated herein by reference in its entirety.

### TECHNICAL FIELD

This disclosure relates to an integrated tap and home network filter.

### BACKGROUND

In general, a subscriber premise using a whole-home network solution (e.g., Multimedia Over Coaxial Alliance (MoCA)) has a point of entry (PoE) filter (e.g., MoCA filter) installed at a point of entry or demarcation point (e.g., location where a service enters the subscriber premise). Typically, the PoE filter is installed between the PoE of the premise and one or more devices within the premise. When a subscriber installs a whole-home network solution at the subscriber premise, the subscriber is expected to install a filter (e.g., MoCA filter) at the subscriber premise's PoE. Home network signals, such as MoCA signals, may be able to travel upstream through the demarcation point of a subscriber premise (e.g., through a grounding block, network interface, etc.) and on to a cable plant. A MoCA filter serves to block reflected MoCA signals from passing through the PoE and onto the cable plant. Typically, a MoCA filter may also reflect MoCA signals back into the customer premise, thus sending the MoCA signal back downstream to MoCA compatible devices and improving the strength of MoCA signals within the customer premise.

If a PoE filter is not installed or is installed backwards, problems can occur within the whole-home network solution, at a network upstream from the subscriber premise, and at neighboring premises. For example, without the reflecting capability of a MoCA filter at a customer premise's PoE, the strength of MoCA signals within the customer premise may be weakened. As another example, if a MoCA filter is not installed at the premise's PoE or is installed incorrectly, MoCA signals can travel onto and disrupt the upstream cable plant. Without the filtering capability of a MoCA filter at the PoE, MoCA signals may be able to travel into neighboring customer premises that share the same cable tap. Therefore, a need exists for improving methods and systems for preventing home network signals from traveling upstream from a customer premise onto a cable plant.

### BRIEF DESCRIPTION OF THE DRAWINGS

FIG. 1 is a block diagram illustrating an example network environment operable to filter signals going into and signals coming out of a customer premise.

FIG. 2 is a block diagram illustrating an example tap operable to filter signals going into and signals coming out of a customer premise.

FIG. 3 is a block diagram illustrating an example tap operable to filter signals going into and signals coming out of a customer premise.

FIG. 4 is a block diagram illustrating an example network operable to facilitate the filtering of home-network signals at a tap.

FIG. 5 is a flowchart illustrating an example process operable to facilitate the filtering of home-network signals at a tap.

Like reference numbers and designations in the various drawings indicate like elements.

### DETAILED DESCRIPTION

It is desirable to improve upon methods and systems for filtering signals going into and coming out of a customer premise while preventing home network signals from traveling upstream from the customer premise onto a cable plant. Methods and systems are described herein for facilitating the filtering of home network signals at a tap outside of a customer premise. In embodiments, a home network filter (e.g., PoE filter, MoCA filter, or any other filter configured to keep home networking signals within a customer premise) can be integrated into a tap outside of a customer premise. For example, a MoCA filter can be placed at one or more outputs of a cable plant tap. The filter can block upstream signals of a predetermined frequency from passing from a customer premise to the cable plant. Integration of a home network filter at a tap can simplify installation of whole-home network solutions by eliminating the need to install a PoE filter at the demarcation point within a customer premise.

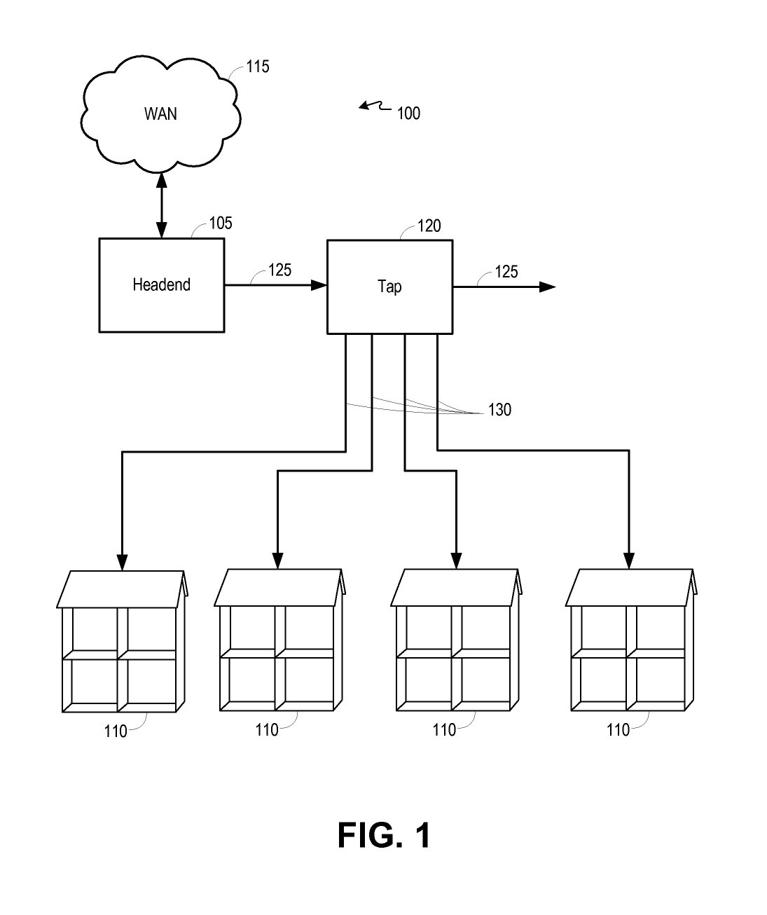

FIG. 1 is a block diagram illustrating an example network environment 100 operable to filter signals going into and signals coming out of a customer premise. In embodiments, a headend 105 can provide video service(s), data service(s) and/or voice services to customer premises 110 in one or more subscriber groups (e.g., service group(s)). In embodiments, the headend 105 can route communications between one or more customer premises 110 and one or more wide-area networks (WAN) 115.

In embodiments, a tap 120 can receive a service feed 125. The service feed 125 may include various signal types such as broadcast, multicast, narrowcast, and other signals that are designated for one or more customer premises 110. In embodiments, the tap 120 can split a portion of the service feed 125 and can output the portion as one or more customer signals 130, each customer signal 130 being output to a designated customer premise 110. In embodiments, the tap 120 can output the service feed 125 to a downstream network component, such as another tap.

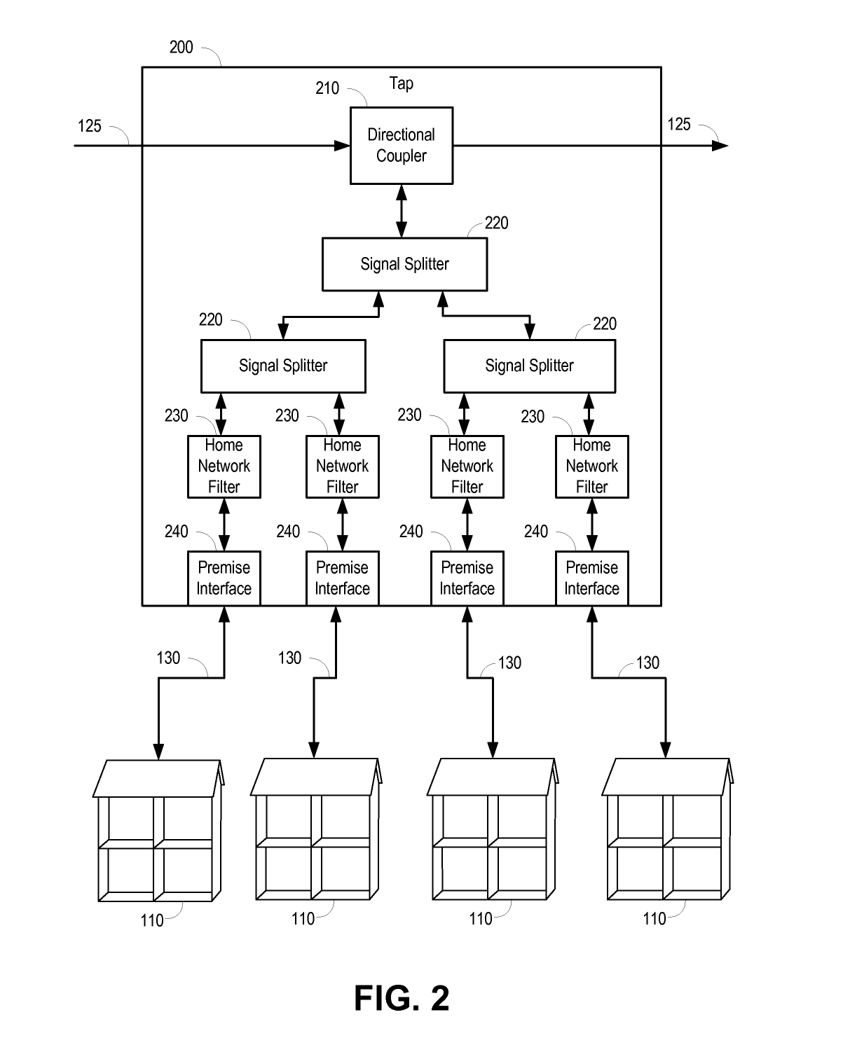

FIG. 2 is a block diagram illustrating an example tap 200 operable to filter signals going into and signals coming out of a customer premise. In embodiments, a tap 200 may include a directional coupler 210, one or more signal splitters 220, one or more home network filters 230 and one or more premise interfaces 240. In embodiments, a tap 200 can receive a service feed 125, split the service feed into one or more customer signals 130, and output the service feed 125 to a downstream network component, such as another tap.

In embodiments, the directional coupler 210 can receive the service feed 125, split off a portion of the service feed 125 (e.g., a coupled signal), output the coupled signal to a signal splitter 220, and output the remainder of the service feed 125 to a downstream network component. The power of the coupled signal can be based upon the number of network components receiving the service feed 125 and/or the number of signal splitters 220 within the tap 200.

In embodiments, a signal splitter 220 can receive a signal, split the signal into two signals, and can output each of the two signals to either another signal splitter 220 or a home network filter 230. The power of the two signals can be equal to each other, with each signal having half the power of the signal received by the signal splitter 220. In embodiments, the number of signal splitters 220 within the tap 200 can be based upon the number of customer premises 110 serviced by the tap 200.

In embodiments, the one or more home network filters 230 can filter signals coming from a customer premise 110. For example, a home network filter 230 can prevent a home networking signal (e.g., MoCA signal) from traveling past the home network filter 230 and onto the service feed 125. The home network filter 230 can be configured to block signals within a predetermined frequency range that is associated with MoCA signals (e.g., 1.1-1.6 gigahertz (GHz) or any other range of frequencies designated for MoCA communications). In embodiments, the home network filter can be configured to reflect signals coming from the customer premise 110 within a predetermined frequency range (e.g., a frequency range established for MoCA signals), and the home network filter can allow signals coming from the customer premise 110 outside of the predetermined frequency range to pass.

In embodiments, the tap 200 may include components configured to support new services (e.g., new and/or updated specifications such as Data Over Cable Service Interface Specification). For example, the tap 200 may include components capable of supporting frequencies up to and beyond 1.8 GHz. In embodiments, the tap 200 can be configured to allow signals at frequencies up to and beyond 1.8 GHz to pass from the service feed 125 into a designated customer premise 110, and configured to block MoCA signals (e.g., signals within the frequency range of 1.1-1.6 GHz) from passing from a customer premise 110 to a service feed 125. For example, each home network filter 230 can be switchable such that the home network filter 230 allows signals having frequencies within a predetermined range associated with a home network (e.g., MoCA signals) to pass downstream to a designated customer premise 110, and the home network filter 230 blocks and/or reflects signals having frequencies within the predetermined range associated with the home network and traveling upstream from a customer premise 110. It will be appreciated by those skilled in the art that various techniques and/or hardware components may be used to give the home network filter 230 switching capability.

In embodiments, the one or more premise interfaces 240 can provide an interface for delivering communications to and receiving communications from the one or more customer premises 110. In embodiments, a home network filter 230 and a premise interface 240 can be integrated as a single component.

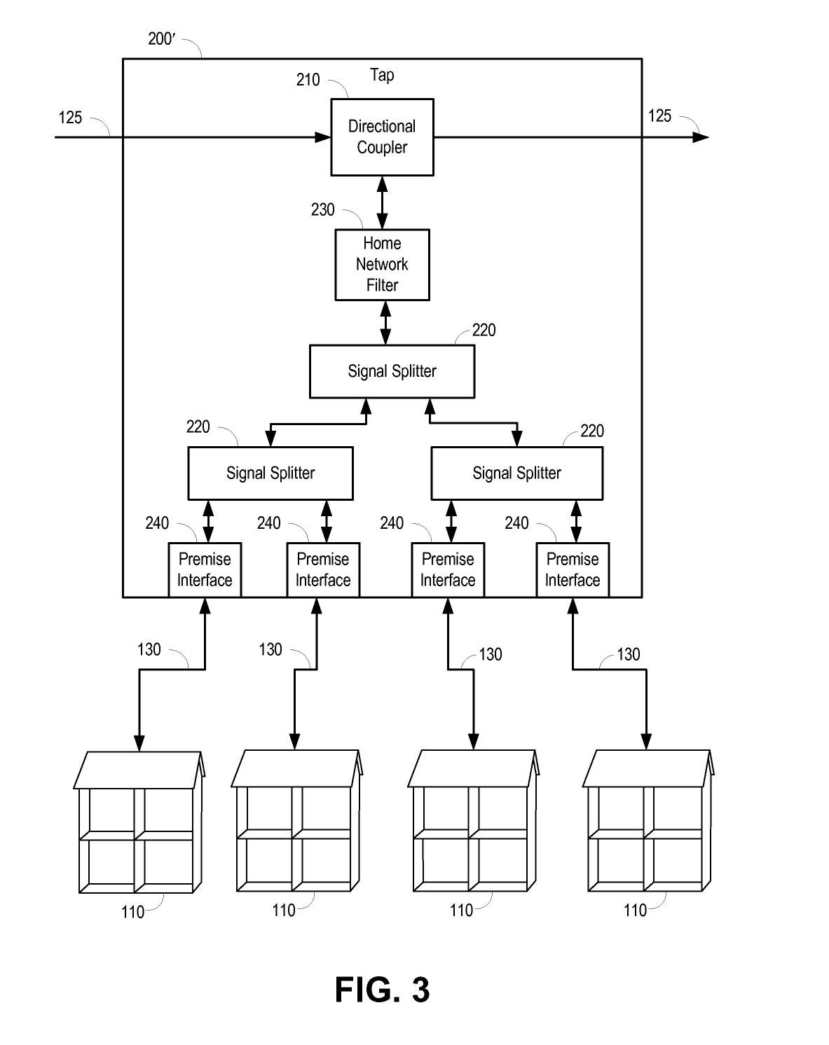

FIG. 3 is a block diagram illustrating an example tap 200′ operable to filter signals going into and signals coming out of a customer premise. In embodiments, a tap 200′ may include a directional coupler 210, one or more signal splitters 220, a home network filter 230 and one or more premise interfaces 240. In embodiments, a tap 200′ can receive a service feed 125, split the service feed into one or more customer signals 130, and output the service feed 125 to a downstream network component, such as another tap.

In embodiments, the directional coupler 210 can receive the service feed 125, split off a portion of the service feed 125 (e.g., coupled signal), output the coupled signal to a home network filter, and output the remainder of the service feed 125 to a downstream network component. The power of the coupled signal can be based upon the number of network components receiving the service feed 125 and/or the number of signal splitters 220 within the tap 200′.

In embodiments, the home network filter 230 can filter signals coming from a customer premise 110. For example, a home network filter 230 can prevent a MoCA signal from traveling past the home network filter 230 and onto the service feed 125. The home network filter 230 can be configured to block signals within a predetermined frequency range that is associated with MoCA signals (e.g., 1.1-1.6 gigahertz (GHz) or any other range of frequencies designated for MoCA communications). In embodiments, the home network filter can be configured to reflect signals coming from the customer premise 110 within a predetermined frequency range (e.g., a frequency range established for MoCA signals), and the home network filter can allow signals coming from the customer premise 110 outside of the predetermined frequency range to pass.

In embodiments, the tap 200′ may include components configured to support new services (e.g., new and/or updated specifications such as Data Over Cable Service Interface Specification). For example, the tap 200′ may include components capable of supporting frequencies up to and beyond 1.8 GHz. In embodiments, the tap 200′ can be configured to allow signals at frequencies up to and beyond 1.8 GHz to pass from the service feed 125 into a designated customer premise 110, and configured to block MoCA signals (e.g., signals within the frequency range of 1.1-1.6 GHz) from passing from a customer premise 110 to a service feed 125. For example, the home network filter 230 can be switchable such that the home network filter 230 allows signals having frequencies within a predetermined range associated with a home network (e.g., MoCA signals) to pass downstream to a designated customer premise 110, and the home network filter 230 blocks and/or reflects signals having frequencies within the predetermined range associated with the home network and traveling upstream from a customer premise 110.

In embodiments, a signal splitter 220 can receive a signal, split the signal into two signals, and can output each of the two signals to either another signal splitter 220 or a home network filter 230. The power of the two signals can be equal to each other, with each signal having half the power of the signal received by the signal splitter 220. In embodiments, the number of signal splitters 220 within the tap 200′ can be based upon the number of customer premises 110 serviced by the tap 200′. In embodiments, the one or more premise interfaces 220 can provide an interface for delivering communications to and receiving communications from the one or more customer premises 110.

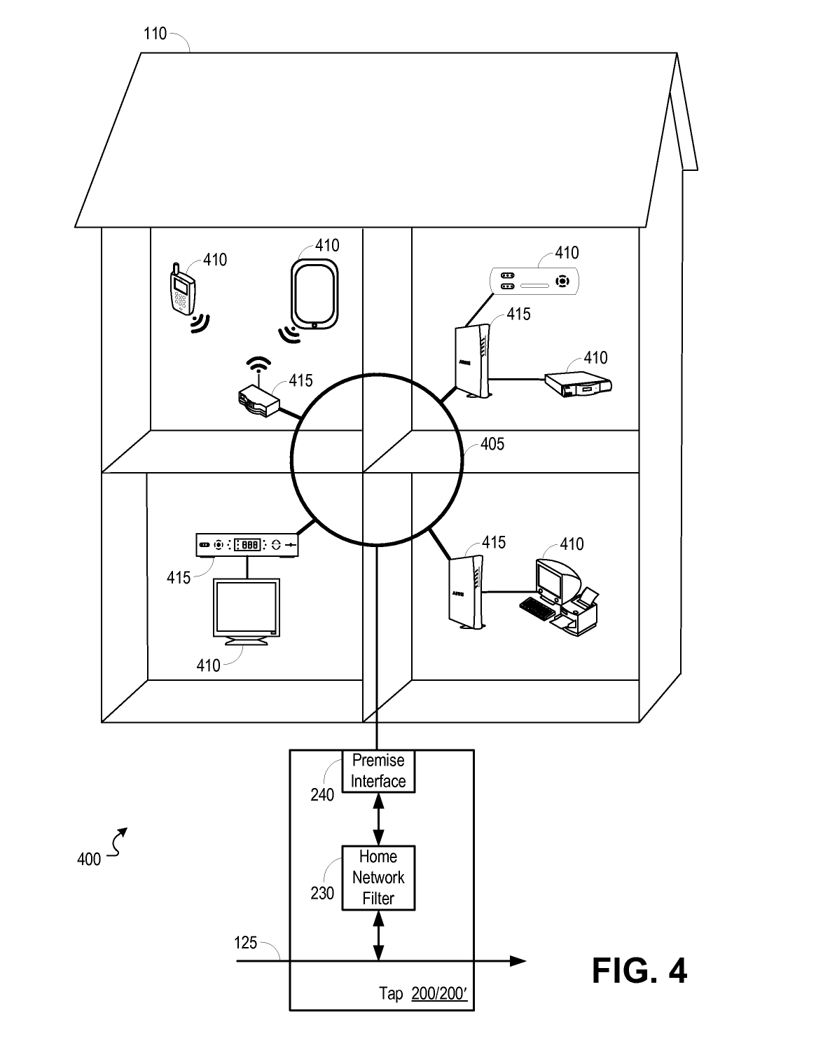

FIG. 4 is a block diagram illustrating an example network 400 operable to facilitate the filtering of home-network signals at a tap. In embodiments, a home network 405 can be used to deliver video, data, and/or voice services to one or more client devices (e.g., client devices 410) within a customer premise 110 and to facilitate communications between the one or more client devices. Client devices 410 may include televisions, computers, mobile devices, tablets, video game consoles, and various other devices capable of connecting to and communicating over the home network 405. In embodiments, the various client devices 410 can connect to and communicate through one or more customer premise equipment (CPE) devices 415 (e.g., gateway, modem, set-top box, etc.).

In embodiments, the home network 405 may include a MoCA network. The one or more client devices 410 connected to the home network 405 can communicate with each other and with CPE devices 415 connected to the home network 405. Communications to and from client devices 410 can be passed at one or more of a variety of frequency ranges established for a network interface (e.g., WiFi, MoCA, etc.). For example, MoCA signals can be transported through a MoCA network within a predetermined range of frequencies established for MoCA communications. As client devices 410 and CPE devices 415 communicate with each other over a MoCA network, MoCA signals can exit the customer premise 110 and reach a tap 200/200′.

In embodiments, a home network filter 230 (e.g., a MoCA filter) at the tap 200/200′ can be positioned in between a service feed 125 and a premise interface 240. The home network filter 230 can prevent a MoCA signal from passing onto the service feed 125. In embodiments, the home network filter 230 can be configured to reflect signals coming from the customer premise 110 within a predetermined frequency range (e.g., a frequency range established for MoCA signals), and the home network filter 230 can allow signals coming from the customer premise 110 outside of the predetermined frequency range to pass. For example, the home network filter 230 can reflect MoCA signals back into the customer premise 110, thereby strengthening a MoCA network within the customer premise 110.

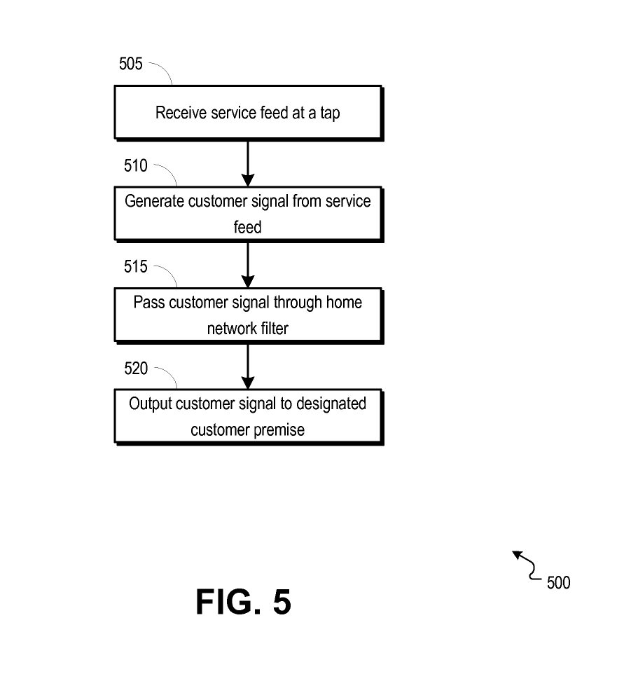

FIG. 5 is a flowchart illustrating an example process 500 operable to facilitate the filtering of home-network signals at a tap. The process 500 can start at 505 when a service feed is received at a tap. In embodiments, a service feed 125 of FIG. 1 can be received at a tap 200/200′, and the service feed 125 may include various signal types such as broadcast, multicast, narrowcast, and other signals that are designated for one or more customer premises (e.g., customer premises 110 of FIG. 1).

At 510, one or more customer signals can be generated from the service feed 125. In embodiments, a portion of the service feed 125 (e.g., coupled signal) can be split off of the service feed 125 by a directional coupler 210 of FIG. 2. The portion of the service feed 125 (e.g., coupled signal) can be split into multiple customer signals 130 of FIG. 1 by passing the portion of the service feed 125 through one or more signal splitters 220 of FIG. 2.

At 515, a customer signal can be passed through a home network filter. In embodiments, a coupled signal can be passed through a home network filter 230 before being split by a signal splitter 220 (e.g., the signal split off of the service feed 125 can pass from the directional coupler 210 to a home network filter 230), or a customer signal can be passed through a home network filter after being split by one or more signal splitters 220 (e.g., each customer signal can pass through a home network filter before being output to a designated customer premise). The one or more home network filters 230 can block MoCA signals from passing from a customer premise 110 to the service feed 125. In embodiments, the one or more home network filters 230 can be switchable such that signals at all frequencies can pass downstream from the service feed 125 to a designated customer premise 110, but frequencies within a predetermined range (e.g., frequency range designated for MoCA signals) that are traveling upstream from a customer premise 110 can be blocked and/or reflected back into the customer premise 110. At 520, after passing through a home network filter 230, a customer signal 130 can be output to a designated customer premise 110 through a premise interface 240.

Those skilled in the art will appreciate that the invention improves upon methods, systems and apparatuses for providing home network solutions to subscribers. A network tap described herein includes a home network filter that is operable to prevent signals at predetermined frequencies from passing from a customer premise onto a service feed servicing the customer premise. In embodiments, one or more MoCA filters can be embedded within a cable tap, each MoCA filter being placed between an interface to a customer premise and a service feed servicing the customer premise. A MoCA filter embedded within a cable tap can block MoCA signals from passing onto a service feed and can reflect MoCA signals back into a customer premise.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The apparatuses described herein can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving a signal at a tap;
splitting the signal into one or more output signals;
passing each of the one or more output signals through a home network filter; and
after passing each of the one or more output signals through a home network filter, outputting each output signal to a point of entry at a designated customer premise.

2. The method of claim 1, wherein the home network filter prevents signals having a frequency within a predetermined frequency range from passing from the customer premise through the home network filter.

3. The method of claim 2, wherein the predetermined frequency range comprises frequencies that are designated for home network signals.

4. The method of claim 1, wherein the home network filter reflects signals having a frequency within a predetermined frequency range back into a home network from which the signals are received.

5. The method of claim 4, wherein the predetermined frequency range comprises frequencies that are designated for home network signals.

6. The method of claim 1, wherein a home network filter is disabled when passing an output signal through the home network filter.

7. The method of claim 1, wherein a home network filter comprises a switch configured to disable the home network filter when passing a downstream signal through the home network filter and to enable the home network filter when passing an upstream signal through the home network filter.

8. A method comprising:
receiving a signal at a tap;
splitting the received signal into a first signal and a second signal;
passing the first signal through a home network filter;
after passing the first signal through the home network filter, splitting the first signal at one or more signal splitters, thus generating a plurality of customer signals; and
outputting each of the customer signals to a point of entry at a designated customer premise.

9. The method of claim 8, wherein the home network filter prevents signals having a frequency within a predetermined frequency range from passing from the customer premise through the home network filter.

10. The method of claim 9, wherein the predetermined frequency range comprises frequencies that are designated for home network signals.

11. The method of claim 8, wherein the home network filter reflects signals having a frequency within a predetermined frequency range back into a home network from which the signals are received.

12. The method of claim 11, wherein the predetermined frequency range comprises frequencies that are designated for home network signals.

13. The method of claim 8, wherein the home network filter is disabled when passing the first signal through the home network filter.

14. The method of claim 8, wherein the home network filter comprises a switch configured to disable the home network filter when passing a downstream signal through the home network filter and to enable the home network filter when passing an upstream signal through the home network filter.

15. An apparatus comprising:
a first interface configured to be used to receive a signal;
a coupler configured to output a coupled signal associated with the received signal;
one or more signal splitters configured to split the coupled signal into one or more output signals;
one or more home network filters configured to prevent signals having a frequency within a predetermined frequency range from passing through the home network filters; and
a second interface configured to be used to output each of the one or more output signals to a point of entry at a designated customer premise.

16. The apparatus of claim 15, wherein the coupled signal is passed through a home network filter before being received by a signal splitter.

17. The apparatus of claim 15, wherein each of the one or more output signals is passed through a home network filter before being output to a designated customer premise.

18. The apparatus of claim 15, wherein the predetermined frequency range comprises frequencies that are designated for home network signals.

19. The apparatus of claim 15, wherein the one or more home network filters are further configured to reflect signals having a frequency within the predetermined frequency range back into a home network from which the signals are received.

20. The apparatus of claim 15, wherein each of the one or more home network filters comprises a switch configured to disable the home network filter when passing a downstream signal through the home network filter and to enable the home network filter when passing an upstream signal through the home network filter.
